(19) United States
(12) Patent Application Publication
(10) Pub. No.: US 2025/0343243 A1
(43) Pub. Date: Nov. 6, 2025

(54) POSITIVE ELECTRODE FOR NON-AQUEOUS ELECTROLYTE SECONDARY BATTERY, NON-AQUEOUS ELECTROLYTE SECONDARY BATTERY USING SAME, BATTERY MODULE, AND BATTERY SYSTEM

(71) Applicant: SEKISUI CHEMICAL CO., LTD., Osaka (JP)

(72) Inventors: Hikaru YOSHIKAWA, Tsukuba-shi (JP); Yuichi SABI, Tsukuba-shi (JP)

(73) Assignee: SEKISUI CHEMICAL CO., LTD., Osaka (JP)

(21) Appl. No.: 18/878,310

(22) PCT Filed: Jul. 3, 2023
(86) PCT No.: PCT/JP2023/024546

§ 371 Date: Dec. 23, 2024

(30) Foreign Application Priority Data
Jul. 1, 2022 (JP) 2022-107163

(51) Int. Cl. H01M 4/62; H01M 4/131; H01M 4/36; H01M 4/58; H01M 10/0525

(52) U.S. Cl. CPC H01M 4/628; H01M 4/131; H01M 4/366; H01M 4/5825; H01M 4/625; H01M 10/0525

(57) ABSTRACT

A positive electrode for a non-aqueous electrolyte secondary battery, including a positive electrode current collector and a positive electrode active material layer including one or more positive electrode active material particles provided on one or both surfaces of the positive electrode current collector. The positive electrode active material layer includes carbon atoms and iron atoms, and Cmax/Femax is 10.0 or more and 35.0 or less, which is a ratio of the most frequent carbon atom intensity Cmax to the most frequent iron atom intensity Femax, wherein the Cmax and the Femax are obtained from histograms of carbon atom intensity and iron atom intensity, each determined by performing scanning Auger electron spectroscopy with respect to a total of 65,536 measurement points formed by vertically aligned 256 points×horizontally aligned 256 points within an area of 100 μm×100 μm on a surface of the positive electrode active material layer.

### TECHNICAL FIELD

The present invention relates to a positive electrode for non-aqueous electrolyte secondary battery, as well as a non-aqueous electrolyte secondary battery, a battery module, and a battery system, each using the positive electrode.

Priority is claimed on Japanese Patent Application No. 2022-107163, filed Jul. 1, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a current collector.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Document 1 proposes a non-aqueous electrolyte secondary battery having a positive electrode containing spherical LiNiO₂ particles obtained by a specific manufacturing method. The invention in Patent Document 1 aims to improve battery capacity.

### PRIOR ART DOCUMENT

### Patent Document

Patent Document 2: Japanese Patent Granted Publication No. 3434873

### SUMMARY OF THE INVENTION

### Problems to be Solved by the Invention

However, there has been a demand for non-aqueous electrolyte secondary batteries to have improved output performance in extremely low-temperature environments (e.g., −40 to −20° C.). In addition, there has been a demand for non-aqueous electrolyte secondary batteries to maintain their output performance even after repeated charge-discharge cycles.

The present invention provides a positive electrode for non-aqueous electrolyte secondary batteries that can improve non-aqueous electrolyte secondary batteries in terms of output performance in low-temperature environments and cycle performance.

### Means for Solving the Problems

As a result of extensive and intensive studies, the present inventors have made the following findings. By allowing an appropriate amount of conductive carbon to be present in the positive electrode active material layer in an appropriate state to reduce the resistance difference between the positive electrode active material particles, excellent conductive path can be formed. It has been found that improved conductive path increases the output performance in low-temperature environments and enables the output performance in low-temperature environments to be maintained after charge/discharge cycles in room temperature environments. Based on this finding, the present invention has been completed.

The embodiments of the present invention are as follows.

<1>

A positive electrode for a non-aqueous electrolyte secondary battery, comprising a positive electrode current collector and a positive electrode active material layer which comprises one or more positive electrode active material particles and is provided on one or both surfaces of the positive electrode current collector, wherein:
the positive electrode active material layer comprises carbon atoms and iron atoms, and
Cmax/Femax is 10.0 or more and 35.0 or less, which is a ratio of the most frequent carbon atom intensity Cmax to the most frequent iron atom intensity Femax, wherein the Cmax and the Femax are obtained from histograms of carbon atom intensity and iron atom intensity, each determined by performing scanning Auger electron spectroscopy with respect to a total of 65,536 measurement points formed by vertically aligned 256 points×horizontally aligned 256 points within an area of 100 μm×100 μm on a surface of the positive electrode active material layer.
   <2>

The positive electrode according to <1>, wherein C90/C10 is 1.0 or more and 2.5 or less, which is a ratio of C90 that is a top 10% value to C10 that is in a bottom 10% value, wherein the C90 and the C10 are obtained from the histogram of the carbon atom intensity determined by performing the scanning Auger electron spectroscopy with respect to the measurement points.

<3>

The positive electrode according to <1> or <2>, wherein at least a part of the positive electrode active material particles has a core section formed of a positive electrode active material and an active material coating section that covers at least a part of surface of the core section, and the active material coating section comprises conductive carbon.

<4>

The positive electrode according to <3>, wherein an amount of the conductive carbon in the positive electrode active material layer is 0.5% by mass or more and less than 3% by mass, based on a total mass of the positive electrode active material layer.

<5>

The positive electrode for a non-aqueous electrolyte secondary battery according to any one of <1> to <4>, wherein the positive electrode current collector has a current collector main body formed of a metal material, and a current collector coating layer covering at least a part of surface of the current collector main body,
the current collector coating layer faces the positive electrode active material layer, and
the current collector coating layer comprises conductive carbon.
   <6>

The positive electrode active material according to any one of <1> to <5>, wherein the positive electrode active material particles comprise a compound represented by a formula LiFeₓM₍₁₋ₓ₎PO₄, wherein 0≤x≤1, M is Co, Ni, Mn, Al, Ti or Zr.

<6-1>

The positive electrode active material according to any one of <3> to <5>, wherein the core section comprises a compound represented by a formula LiFeₓM₍₁₋ₓ₎PO₄, wherein 0≤x≤1, M is Co, Ni, Mn, Al, Ti or Zr.

<6-2>

The positive electrode according to <6-1>, wherein the compound is lithium iron phosphate.

<7>

The positive electrode according to any one of <1> to <6-2>, wherein the positive electrode active material layer further comprises a conducting agent.

<8>

The positive electrode according to any one of <1> to <6-2>, wherein the positive electrode active material layer does not contain a conducting agent.

<8-1>

The positive electrode according to any one of <1> to <8> (including <6-1> and <6-2>), wherein the Cmax/Femax is 14.0 or more and 18.0 or less.

<8-2>

The positive electrode according to any one of <1> to <8> (including <6-1> and <6-2>), wherein the Cmax/Femax is 14.5 or more and 17.0 or less.

<8-3>

The positive electrode according to any one of <1> to <8> (including <6-1> and <6-2>), wherein the Cmax/Femax is 15.5 or more and 17.0 or less.

<9>

A non-aqueous electrolyte secondary battery, including the positive electrode of any one of <1> to <8> (including <6-1>, <6-2>, <8-1> to <8-3>), a negative electrode, and a non-aqueous electrolyte disposed between the positive electrode and the negative electrode.

<10>

A battery module or battery system including a plurality of the non-aqueous electrolyte secondary batteries of <9>.

### Effect of the Invention

The present invention can improve non-aqueous electrolyte secondary batteries in terms of output performance in low-temperature environments and cycle performance.

### BRIEF DESCRIPTION OF THE DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

FIG. 3 is a diagram showing carbon atom intensity distributions in Examples 1 to 3 and Comparative Examples 1 to 3.

FIG. 4 is a diagram showing iron atom intensity distributions in Examples 1 to 3 and Comparative Examples 1 to 3.

### EMBODIMENTS TO CARRY OUT THE INVENTION

In the present specification and claims, “to” indicating a numerical range means that the numerical values described before and after “to” are included as the lower limit and the upper limit of the range.

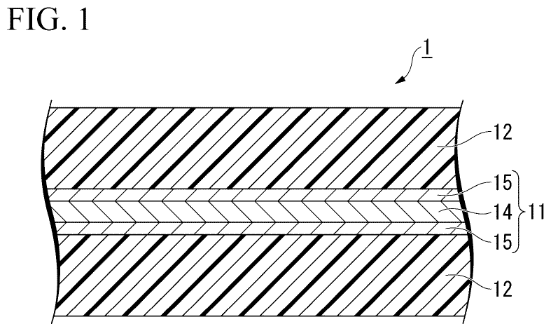

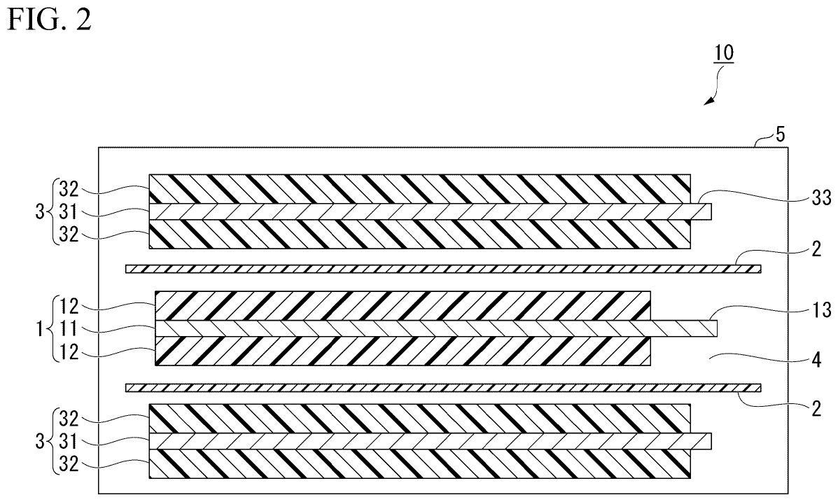

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

Hereinbelow, the present invention are described with reference to embodiments of the present invention.

### (Positive Electrode for Non-Aqueous Electrolyte Secondary Battery)

As shown in FIG. 1, the positive electrode for a non-aqueous electrolyte secondary battery (also simply referred to as “positive electrode”) 1 according to the present embodiment has a positive electrode current collector 11 and a positive electrode active material layer 12.

In the present embodiment, the positive electrode active material layer 12 is present on both sides of the positive electrode collector 11. However, in the present invention, the positive electrode active material layer 12 may be present on only one side of the positive electrode collector 11.

In the example shown in FIG. 1, the positive electrode current collector 11 has a positive electrode current collector main body 14 and current collector coating layers 15 that cover the positive electrode current collector main body 14 on its surfaces facing the positive electrode active material layers 12. The positive electrode current collector main body 14 alone may be used as the positive electrode current collector 11.

### <Positive Electrode Active Material Layer>

The positive electrode active material layer 12 includes one or more positive electrode active material particles.

The positive electrode active material layer 12 preferably further includes a binder.

The positive electrode active material layer 12 may further include a conducting agent. In the context of the present specification, the term “conducting agent” refers to a conductive material of a particulate shape, a fibrous shape, etc., which is mixed with the positive electrode active material for the preparation of the positive electrode active material layer or formed in the positive electrode active material layer, and is caused to be present in the positive electrode active material layer in a form connecting the particles of the positive electrode active material.

The positive electrode active material layer 12 may further include a dispersant.

The amount of the positive electrode active material particles is preferably 80.0 to 99.9% by mass, and more preferably 90 to 99.5% by mass, based on the total mass of the positive electrode active material layer 12.

The thickness of the positive electrode active material layer (total thickness of the positive electrode active material layers in the case where the positive electrode active material layers are formed on both sides of the positive electrode current collector) is preferably 30 to 500 μm, more preferably 40 to 400 μm, particularly preferably 50 to 300 μm. When the thickness of the positive electrode active material layer is not less than the lower limit value of the above range, the energy density of a battery with the positive electrode incorporated therein tends to improve. When the thickness is not more than the upper limit value of the above range, the peel strength of the positive electrode active material layer can be improved, thereby preventing delamination of the positive electrode active material layer during charging/discharging.

### [Positive Electrode Active Material Particles]

The positive electrode active material particles include a positive electrode active material. At least a part of the positive electrode active material particles is preferably a coated particle.

In the coated particles, a coated section containing a conductive material (hereinafter, also referred to as “coated section of the active material”) is present on the surfaces of the positive electrode active material particles. The active material coating section of the active material particles enables the positive electrode active material particles to further enhance the battery capacity and cycling performance.

For example, the active material coating section is formed in advance on the surface of the positive electrode active material particles, and is present on the surface of the positive electrode active material particles in the positive electrode active material layer. That is, the active material coating section in the present specification is not one newly formed in the steps following the preparation step of a positive electrode composition. In addition, the active material coating section is not one that comes off in the steps following the preparation step of a positive electrode composition.

For example, the active material coating section stays on the surface of the core section of the positive electrode active material particles even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section of the active material particles preferably covers 50% or more, preferably 70% or more, and more preferably 90% or more of the total area of the entire outer surfaces of the positive electrode active material particles.

That is, the coated particles have a core section that is a positive electrode active material and an active material coating section that covers the surface of the core section, and the area ratio (coverage) of the active material coating section with respect to the surface area of the core section is preferably 50% or more, more preferably 70% or more, and even more preferably 90% or more.

Examples of the method for producing the coated particles include a sintering method and a vapor deposition method.

Examples of the sintering method include a method that sinters an active material composition (for example, a slurry) containing the positive electrode active material particles and an organic substance at 500 to 1000° C. for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, saccharides (e.g., sucrose, glucose and lactose), carboxylic acids (e.g., malic acid and citric acid), unsaturated monohydric alcohols (e.g., allyl alcohol and propargyl alcohol), ascorbic acid, and polyvinyl alcohol. This sintering method sinters an active material composition to allow carbon in the organic material to be fused to the surface of the positive electrode active material to thereby form the active material coating section.

Another example of the sintering method is the so-called impact sintering coating method.

The impact sintering coating method is, for example, carried our as follows. In an impact sintering coating device, a burner is ignited using a mixed gas of a hydrocarbon and oxygen as a fuel to burn the mixed gas in a combustion chamber, thereby generating a flame, wherein the amount of oxygen is adjusted so as not to exceed its equivalent amount that allows complete combustion of the fuel, to thereby lower the flame temperature. A powder supply nozzle is installed downstream thereof, from which a solid-liquid-gas three-phase mixture containing a combustion gas as well as a slurry formed by dissolving an organic substance for coating in a solvent is injected toward the flame. The injected fine powder is accelerated at a temperature not higher than the transformation temperature, the sublimation temperature, and the evaporation temperature of the powder material by increasing the amount of combustion gas maintained at room temperature to lower the temperature of the injected fine powder. This allows the particles of the powder to be instantly fused on the active material by impact, thereby forming coated particles of the positive electrode active material.

Examples of the vapor deposition method include a vapor phase deposition method such as a physical vapor deposition method (PVD) and a chemical vapor deposition method (CVD), and a liquid phase deposition method such as plating.

The coverage can be measured by a method as follows. First, the particles in the positive electrode active material layer are analyzed by the energy dispersive X-ray spectroscopy (TEM-EDX) using a transmission electron microscope. Specifically, an elemental analysis is performed by EDX with respect to the outer peripheral portion of the positive electrode active material particles in a TEM image. The elemental analysis is performed on carbon to identify the carbon covering the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

Further, the active material coating section is a layer directly formed on the surface of particles (core section) composed of only the positive electrode active material, which has a thickness of 1 nm to 100 nm, preferably 5 nm to 50 nm. This thickness can be determined by the above-mentioned TEM-EDX used for the measurement of the coverage.

In the present invention, the area ratio (coverage) of the active material coating section in the coated particles is particularly preferably 100% with respect to the surface area of the core section.

This ratio is an average value for all the positive electrode active material particles present in the positive electrode active material layer. As long as this average value is not less than the above lower limit value, the positive electrode active material layer may contain positive electrode active material particles without the active material coating section. When the positive electrode active material particles (single particles) without the active material coating section are present in the positive electrode active material layer, the amount thereof is not particularly limited as long as the “Cmax/Femax” described below falls within the specified range, but is preferably 30% by mass or less, more preferably 20% by mass or less, particularly preferably 10% by mass or less, with respect to the total mass of the positive electrode active material particles present in the positive electrode active material layer.

When the active material coating section is composed of carbon, it is preferable to adjust the resistance of the active material surface to fall within the range of 10⁶ to 10⁹Ω. When the surface of the core section is covered with highly conductive carbon black, carbon nanotubes, graphene, etc., the resistance of the positive electrode active material particles decreases. When a charge/discharge cycle is performed, a lower resistance of the positive electrode active material particles results in a higher side reactivity with the electrolyte. Therefore, by setting the resistivity of the surface of the positive electrode active material particles within the above range, it is possible to improve the battery performances and extend the battery life.

The resistance of the active material surface can be measured, for example, using a scanning spread resistance microscope (SSRM).

The positive electrode active material preferably contains a compound having an olivine crystal structure. When at least a part of the positive electrode active material particles are coated particles, the core section preferably contains a compound having an olivine crystal structure.

The compound having an olivine crystal structure is preferably a compound represented by the following formula: LiFeₓM₍₁₋ₓ₎PO₄(hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also referred to as “lithium iron phosphate”).

The positive electrode active material particles are more preferably lithium iron phosphate particles having, on at least a part of their surfaces, an active material coating section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

For example, the coated lithium iron phosphate particles can be obtained by a method in which a lithium iron phosphate powder is prepared by following the procedure described in Japanese Patent No. 5098146, and at least a part of the surface of lithium iron phosphate particles in the powder is coated with carbon by following the procedure described in GS Yuasa Technical Report, June 2008, Vol. 5, No. 1, pp. 27-31 and the like. Specifically, first, iron oxalate dihydrate, ammonium dihydrogen phosphate, and lithium carbonate are weighed to give a specific molar ratio, and these are pulverized and mixed in an inert atmosphere. Next, the obtained mixture is heat-treated in a nitrogen atmosphere to prepare a lithium iron phosphate powder. Then, the lithium iron phosphate powder is placed in a rotary kiln and heat-treated while supplying methanol vapor with nitrogen as a carrier gas to obtain a powder of lithium iron phosphate particles having at least a part of their surfaces coated with carbon.

For example, the particle size of the lithium iron phosphate powder can be adjusted by optimizing the crushing time in the crushing process. The amount of carbon coating the particles of the lithium iron phosphate powder can be adjusted by optimizing the heating time and temperature in the step of implementing heat treatment while supplying methanol vapor. It is desirable to remove the carbon particles not consumed for coating by subsequent steps such as classification and washing.

The positive electrode active material particles may include at least one type of other positive electrode active material particles including other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al_{z}O₂ with the proviso that x+y+z=1), lithium nickel cobalt manganese oxide (LiNiₓCo_{y}Mn_{z}O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide (LiCoVO₄), as well as nonstoichiometric compounds formed by partially substituting the compounds listed above with metal elements. Examples of the metal element include one or more selected from the group consisting of Mn, Mg, Ni, Co, Cu, Zn and Ge.

The other positive electrode active particles material may have, on at least a part of surfaces thereof, the active material coating section described above.

The amount of the compound having an olivine type crystal structure is preferably 50% by mass or more, preferably 80% by mass or more, and even more preferably 90% by mass or more, based on the total mass of the positive electrode active material particles (including the mass of the active material coating section if present). The amount of the compound having an olivine type crystal structure may be 100% by mass, based on the total mass of the positive electrode active material particles.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material particles. This amount may be 100% by mass.

The thickness of the active material coating section of the positive electrode active material particles is preferably 1 to 100 nm.

The thickness of the active material coating section of the positive electrode active material particles can be measured by a method of measuring the thickness of the active material coating section in a transmission electron microscope (TEM) image of the positive electrode active material particles. The thickness of the active material coating sections on the surfaces of the positive electrode active material particles need not be uniform. It is preferable that the positive electrode active material particles have, on at least a part of surfaces thereof, the active material coating section having a thickness of 1 nm or more, and the maximum thickness of the coated section is 100 nm or less.

The average particle size of the positive electrode active material particles (including the thickness of the active material coating section if present) is preferably 0.1 to 20.0 μm, more preferably 0.5 to 15.0 μm. When two or more types of positive electrode active materials are used, the average particle size of each of such positive electrode active materials may be within the above range.

When the average particle size is not less than the lower limit value of the above range, the dispersibility in the positive electrode composition is improved, and agglomerates are less likely to occur. On the other hand, when the average particle size is not more than the upper limit value of the above range, the specific surface area becomes appropriately large, making it easier to secure an area for reaction during charging and discharging. As a result, the resistance of the battery decreases, input/output performance is less likely to deteriorate, and output performance in low-temperature environments (e.g., −40 to −20° C.) can be improved. Even after repeated charge/discharge cycles in normal temperature environments (e.g., 20 to 30° C.), the output performance in low-temperature environments can be likewise maintained at a high level (i.e., cycle performance is excellent).

The average particle size of the positive electrode active material particles in the present specification is a volume-based median particle size measured using a laser diffraction/scattering particle size distribution analyzer.

### [Binder]

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The binder content relative to the total mass of the positive electrode active material layer 12 is preferably 1.0% by mass or less, more preferably 0.8% by mass or less.

When the positive electrode active material layer 12 contains a binder, the lower limit of the amount of the binder is preferably 0.1% by mass or more, based on the total mass of the positive electrode active material layer 12.1% by mass or more, more preferably 0.3% by mass or more.

### [Conducting Agent]

Examples of the conducting agent contained in the positive electrode active material layer 12 include carbon materials such as graphite, graphene, hard carbon, Ketjen black, acetylene black, and carbon nanotube (CNT). With respect to the conducting agent, a single type thereof may be used alone or two or more types thereof may be used in combination.

The amount of the conducting agent in the positive electrode active material layer 12 is, for example, preferably 3.0% by mass, more preferably 0.5% by mass or more and less than 3.0% by mass or less, more preferably 0.7 to 2.7% by mass, particularly preferably 0.9 to 2.5% by mass, based on the total mass of the positive electrode active material layer 12.

The positive electrode active material layer 12 may not include a conducting agent.

In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

Conducting agent particles that do not contribute to the creation of conductive path may become a site where self-discharge of the battery starts or a cause of undesirable side reactions.

### [Dispersant]

The dispersant contained in the positive electrode active material layer 12 is an organic substance, and examples thereof include polyvinylpyrrolidone (PVP), polyvinyl alcohol (PVA), polyvinyl butyral (PVB), and polyvinylformal (PVF). With respect to these dispersants, a single type thereof may be used individually or two or more types thereof may be used in combination.

The dispersant contributes to improving the dispersion of particles in the positive electrode active material layer. On the other hand, when the dispersant content is too high, resistance is likely to increase.

The amount of the dispersant is preferably 0.5% by mass or less, more preferably 0.2% by mass or less, based on the total mass of the positive electrode active material layer 12.

When the positive electrode active material layer contains a dispersant, the lower limit of the amount of the dispersant is preferably 0.01% by mass or more, more preferably 0.05% by mass or more, based on the total mass of the liquid detergent.

### <<Properties of Positive Electrode Active Material Layer>>

The surface of the positive electrode active material layer 12 (the surface opposite to the surface facing the positive electrode current collector) shows a specific distribution in histograms of carbon atom intensity and iron atom intensity, each determined by performing scanning Auger electron spectroscopy (AES) with respect to respective measurement points. This histogram is one showing the intensity on the horizontal axis and the frequency (number of points within each interval) on the vertical axis.

In the results of AES on a surface of the positive electrode active material layer 12, Cmax/Femax, which is a ratio of the most frequent carbon atom intensity Cmax to the most frequent iron atom intensity Femax, is preferably 10.0 to 35.0, more preferably 10.0 to 30.0, even more preferably 14.0 to 30.0, particularly preferably 14.0 to 18.0, particularly preferably 14.5 to 17.0, most preferably 15.5 to 17.0. When Cmax/Femax is not less than the lower limit value described above, there are less areas with exposed iron (Fe), a component of the active material. When Cmax/Femax is not less than the lower limit value described above, there are less areas that are highly resistive and can inhibit the charge/discharge reaction, so that side reactions that cause deterioration during cycling can be suppressed. This improves cycle performance. When Cmax/Femax is not more than the upper limit value described above, there is a sufficient amount of carbon that imparts conductivity to the surface of the positive electrode active material, so that the low-resistance areas increases, and output performance in low-temperature environments can be improved.

AES is performed on a predetermined area (a square of 100 μm×100 μm) on the surface of the positive electrode active material layer 12. In the predetermined area, measurement points for AES are 65,536 points in total, formed by vertically aligned 256 points×horizontally aligned 256 points. Cmax is the most frequent intensity in the histogram of the carbon atom intensities at the measurement points. Fmax is the most frequent intensity in the histogram of the iron atom intensities at the measurement points.

In the histogram of the carbon atom intensity determined as a result of AES on the surface of the positive electrode active material layer 12, regarding the cumulative frequency (%) from the lower intensity side to the higher intensity side of the histogram, C90/C10, which is a ratio of the top 10% value (C90) to the bottom 10% value (C10), is preferably 1.0 to 2.5, more preferably 1.0 to 2.0. When C90/C10 is within the above range, the amount of carbon present on the active material surface and the uniformity of the coating thickness are allowed to increase, which increases the uniformity of resistance and reduces the number of locations where the charge/discharge reaction is delayed in low-temperature environments, while enabling improvement in output performance and suppression of deterioration even after repeated charge/discharge cycles.

Cmax/Femax obtained from the histograms of carbon atoms and iron atoms in AES can be adjusted by the combination of the type of positive electrode active material particles, the amount of positive electrode active material particles in the positive electrode active material layer, the composition of the positive electrode active material layer, the production conditions (pressure during pressing, stirring conditions during slurry preparation, etc.), and the like.

### <Positive Electrode Current Collector>

The positive electrode current collector 11 of the present embodiment has a positive electrode current collector main body 14 and current collector coating layers 15 provided on both sides of the positive electrode current collector main body 14. The positive electrode current collector 11 may have a current collector coating layer 15 only on one side of the positive electrode collector body 14.

### [Positive Electrode Current Collector Main Body]

Examples of the material of the positive electrode current collector main body 14 include conductive metals such as copper, aluminum, titanium, nickel, and stainless steel.

The positive electrode current collector main body 14 is a foil (metal foil) formed of a metallic material, and may include an oxide film formed on the surface.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

The presence of the current collector coating layer improves the output performance of the non-aqueous electrolyte secondary battery in a low-temperature environment, and further enhances the effect of improving the cycle performance.

The current collector coating layer 15 contains a conductive material.

The conductive material in the current collector coating layer 15 preferably contains carbon (conductive carbon), and more preferably consists exclusively of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.1 to 4.0 μm.

The thickness of the current collector coating layer can be measured by a method that measures the thickness of the coating layer in a transmission electron microscope (TEM) image or a scanning electron microscope (SEM) image of a cross section of the current collector coating layer. The thickness of the current collector coating layer need not be uniform. It is preferable that the current collector coating layer 15 having a thickness of 0.1 μm or more is present on at least a part of the surface of the positive electrode current collector main body 14, and the maximum thickness of the current collector coating layer is 4.0 μm or less.

### <Conductive Carbon Content>

In the present embodiment, the positive electrode active material layer 12 or the current collector coating layer 15 contains conductive carbon.

The amount of the conductive carbon is preferably 0.5% by mass or more and less than 3.0 by mass, more preferably 1.0 to 2.8% by mass, even more preferably 1.2 to 2.6% by mass, based on the total mass of the positive electrode active material layer 12.

When the amount of the conductive carbon in the positive electrode active material layer 12 is not less than the lower limit value of the above range, the amount is sufficient to form a conductive path in the positive electrode active material layer 12, resulting in further enhanced output performance in low-temperature environments. When the amount of the conductive carbon in the positive electrode active material layer 12 is not more than the upper limit value described above, the output performance in low-temperature environments can be further enhanced.

The conductive carbon content based the total mass of the positive electrode active material layer 12 can be measured by Method for measuring conductive carbon content>> described below with respect to a dried product (powder), as a measurement target, obtained by vacuum-drying, at 120° C., the positive electrode active material layer 12 detached from the positive electrode.

For example, the measurement target may be one obtained by detaching the outermost surface of the positive electrode active material layer with a depth of several m using a spatula or the like, and vacuum drying the resulting powder in an environment of 120° C.

The conductive carbon to be measured by the Method for measuring conductive carbon content>> described below includes carbon in the active material coating section and carbon in the conducting agent, but does not include either carbon in the binder or carbon in the dispersant.

### <<Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.
Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100 \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

### [Burning Conditions]

Combustion furnace temperature: 1150° C.,
Temperature of reduction furnace: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH2_{CF}2), molecular weight 64), the conductive carbon content can be calculated by the following formula from the fluoride ion (F·) content (unit: % by mass) measured by combustion ion chromatography based on the tube combustion method, the atomic weight (19) of fluorine in the monomers constituting PVDF, and the atomic weight (12) of carbon in the PVDF.

PVDF content (unit: % by mass)=fluoride ion content (unit: % by mass)×64/38

PVDF-derived carbon amount M4 (unit: % by mass)=fluoride ion content (unit: % by mass)×12/19

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (¹⁹F-NMR).

When the binder is identified as being other than PVDF, the carbon amount M4 attributable to the binder can be calculated by determining the amount (unit: % by mass) of the binder from the measured molecular weight, and the carbon content (unit: % by mass).

When the dispersant is contained, the conductive carbon content (unit: % by mass) can be obtained by subtracting M4 from M3, and further subtracting therefrom the amount of carbon belonging to the dispersant.

These methods are described in the following publications:
Toray Research Center, The TRC News No. 117 (Sep. 2013), pp. 34-37, [Searched on Feb. 10, 2021], Internet <https://www.toray-research.co.jp/technical-info/trcnews/pdf/TRC117(34-37).pdf>
TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context, “near the particle surface” means a region to the depth of approximately 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material particles that are the coated particles described above. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the active material coating section. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer

### <Method for Producing Positive Electrode>

The present embodiment's method for producing the positive electrode 1 includes a composition preparation step of preparing a positive electrode composition containing a positive electrode active material, and a coating step of coating the positive electrode composition on the positive electrode current collector 11.

For example, a positive electrode composition containing a positive electrode active material and a solvent is applied onto the current collector coating layer 15 of the positive electrode collector 11, followed by drying to remove the solvent to form the positive electrode active material layer 12. As a result, a composite laminate 16, which is a laminate of the current collector coating layer 15 and the positive electrode active material layer 12, is provided on the positive electrode current collector main body 14 to form the positive electrode 1.

The positive electrode composition may contain a conducting agent. The positive electrode composition may contain a binder. The positive electrode composition may contain a dispersant.

The positive electrode current collector 11 may be, for example, a product manufactured by forming a current collector coating layer 15 on one or both sides of the positive electrode current collector main body 14, or may be a commercially available product.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

### (Non-Aqueous Electrolyte Secondary Battery)

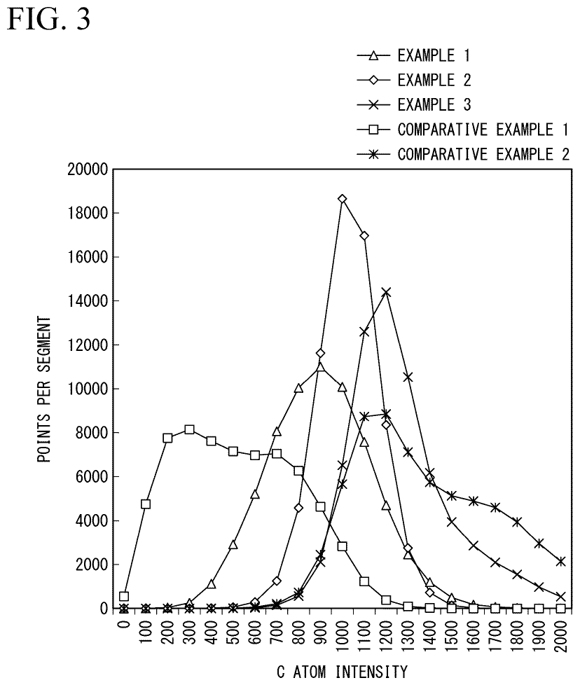

The non-aqueous electrolyte secondary battery 10 of the present embodiment shown in FIG. 3 includes a positive electrode 1 of the present embodiment, a negative electrode 3, and a non-aqueous electrolyte. Further, a separator 2 may be provided. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A current collector coating layer 15 may or may not be present on the surface of the exposed section 13 of the positive electrode current collector. In other words, the positive electrode current collector main body 14 may be exposed. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

FIG. 3 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### <Negative Electrode>

The negative electrode active material layer 32 includes a negative electrode active material. The negative electrode active material layer 32 may further includes a binder. The negative electrode active material layer 32 may further include a conducting agent. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials, lithium titanate (LTO), silicon, silicon monoxide and the like.

Examples of the carbon materials include graphite, graphene, hard carbon, Ketjen black, acetylene black, and carbon nanotube (CNT). With respect to each of the negative electrode active material and the conducting agent, a single type thereof may be used alone or two or more types thereof may be used in combination.

Examples of the material of the negative electrode current collector 31 include those listed above as examples of the material of the positive electrode current collector 11.

Examples of the binder in the negative electrode composition include polyacrylic acid (PAA), lithium polyacrylate (PAALI), polyvinylidene fluoride (PVDF), polyvinylidene fluoride-propylene hexafluoride copolymer (PVDF-HFP), styrene-butadiene rubber (SBR), polyvinyl alcohol (PVA), polyethylene oxide (PEO), polyethylene glycol (PEG), carboxymethyl cellulose (CMC), polyacrylonitrile (PAN), polyimide (PI) and the like. With respect to the binder, a single type thereof may be used alone or two or more types thereof may be used in combination.

Examples of the solvent in the negative electrode composition include water and organic solvents. Examples of the organic solvent include alcohols such as methanol, ethanol, 1-propanol and 2-propanol; chain or cyclic amides such as N-methylpyrrolidone (NMP) and N,N-dimethylformamide (DMF); and ketones such as acetone.

With respect to these solvents, a single type thereof may be used individually or two or more types thereof may be used in combination.

The sum of the amount of the negative electrode active material and the amount of the conducting agent relative to the total mass of the negative electrode active material layer 32 is preferably 80.0 to 99.9% by mass, more preferably 85.0 to 98.0% by mass.

### <Separator>

The separator 2 is disposed between the negative electrode 3 and the positive electrode 1 to prevent a short circuit or the like. The separator 2 may retain a non-aqueous electrolyte solution 4 described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The thickness of the separator 2 is, for example, 5 to 30 μm.

The separator 2 may contain various plasticizers, antioxidants, and flame retardants.

Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### <Non-Aqueous Electrolyte Solution>

The non-aqueous electrolyte solution fills the space between the positive electrode 1 and the negative electrode 3. For example, any of known non-aqueous electrolyte solutions used in lithium ion secondary batteries, electric double layer capacitors and the like can be used.

The non-aqueous electrolyte solution 4 used in the manufacture of the non-aqueous electrolyte secondary battery 10 contains an organic solvent, an electrolyte, and an additive.

The non-aqueous electrolyte secondary battery 10 after manufacture (after initial charging) contains an organic solvent and an electrolyte, and may further contain residues or traces derived from the additives.

The organic solvent is preferably one having tolerance to high voltage.

Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide, 1,2-dimethoxyethane, 1,2-diethoxyethane, tetrohydrafuran, 2-methyltetrahydrofuran, dioxolane, and methyl acetate, as well as mixtures of two or more of these polar solvents.

The electrolyte salt is not particularly limited, and examples thereof include lithium-containing salts such as LiClO₄, LiPF₆, LiBF₄, LiAsF₆, LiCF₃CO₂, LiN(SO₂F)₂, LiN(SO₂CF₃)₂, Li(SO₂CF₂CF₃)₂, LiN(COCF₃)₂, and LiN(COCF₂CF₃)₂, as well as mixture of two or more of these salts.

Examples of additives includes a compound A that contains one or both of a sulfur atom and a nitrogen atom. Each of the additives may be used alone, or two or more of the additives may be used in combination.

Examples of the compound A include lithium sulfonylimide salts such as lithium bis(fluorosulfonyl)imide (LiN(SO₂F)₂, hereafter also referred to as “LiFSI”).

### <Method for Producing Non-Aqueous Electrolyte Secondary Battery>

Examples of the method for producing a non-aqueous electrolyte secondary battery according to the present embodiment include a method in which a positive electrode, a separator, a negative electrode, a non-aqueous electrolyte solution, an exterior body, etc. are put together by a known method to assemble a non-aqueous electrolyte secondary battery.

An example of the method for producing a non-aqueous electrolyte secondary battery according to the present embodiment is described below. For example, an electrode stack is produced in which a positive electrode 1 and a negative electrode 3 are alternately interleaved with a separator 2 interposed therebetween. The electrode laminate is put into an exterior body (casing) 5 such as an aluminum laminate bag. Then, a non-aqueous electrolyte solution (not shown) is injected into the exterior body 5, and the exterior body 5 is sealed to produce a non-aqueous electrolyte secondary battery.

According to the positive electrode of the present embodiment, the specific distribution of carbon atoms on the surface of the positive electrode active material layer enhances the output performance in low-temperature environments and allows the high output performance in low-temperature environments to be maintained even after repeated charge-discharge cycles in room-temperature environments. This is presumably because an appropriate amount of conductive carbon exists in an appropriate state in the positive electrode active material layer, thereby reducing the resistance difference between the positive electrode active material particles and creating a good conductive path.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

### EXAMPLES

Hereinbelow, the present invention will be described with reference to Examples which, however, should not be construed as limiting the present invention.

### <Method of Scanning Auger Electron Spectroscopy, Creation of Histograms, Calculation of Most Frequent Value (Cmax, Femax) and C90/C10>

A scanning Auger electron spectrometer was used to perform scanning Auger electron spectroscopy on the surface of the positive electrode active material layer 12 to acquire information on the chemical shift due to the bonding state of carbon atoms and iron atoms on the surface of the positive electrode active material layer 12. The measurement range of the scanning Auger electron spectroscopy was, for example, set to a square area of 100 μm in length×100 μm in width.

In the square area of 100 μm in length×100 μm in width, measurement was performed with respect to a total of 65,536 measurement points formed by vertically aligned 256 points×horizontally aligned 256 points to obtain the carbon atom intensity and the iron atom intensity, respectively.

Next, the carbon atom intensity and the iron atom intensity measured by scanning Auger electron spectroscopy were each made into a histogram. In this example, a histogram was created with intervals of width 100 for the obtained carbon atom intensity and intervals of width 20 for the iron atom intensity. The intervals of width 100 are, for example, a section of from 0 to less than 100, and a section of from 100 to less than 200. The intervals of width 20 are, for example, a section of from 0 to less than 20, and a section of from 20 to less than 40.

The histogram was created with the intensity on the horizontal axis and the number of measurement points present in the respective intensity intervals on the vertical axis. From the obtained histogram, the interval with the maximum frequency (where the largest number of measurement points are distributed) was identified, and the intensity at the center of the interval was taken as the most frequent intensity.

Regarding the center intensity of the intervals, for example, the center intensity of the interval of from 100 to less than 200 was set to 150.

The most frequent intensity of carbon atoms was taken as Cmax, the most frequent intensity of iron atoms was taken as Femax, and Camax/Femax was calculated. Similarly, C10 as the bottom 10% value and C90 as the top 10% value were calculated from the carbon atom intensity histogram.

The measurement conditions were as shown below.
AES device: SmArt-Tool Auger Nanoprobe, manufactured by ULVAC PHI.
Electron beam: 10 kV, 20 nA.
Measurement range: 100 μm×100 μm square area.

The above AES is only one example, and the absolute value of the intensity obtained varies depending on the type of AES device and the conditions of the electron beam during measurement. Even so, the relationship between Cmax and Femax, Cmax/Femax, is presumably to be maintained. For this reason, the intervals used to obtain the histogram may be changed as appropriate depending on the magnitude of the peak intensity, and the main purpose of this analysis method is to obtain ratios such as Cmax/Femax and C90/C10.

### (Evaluation Method)

### <Low Temperature Output Evaluation and Charge/Discharge Cycle Test>

Low temperature output evaluation and charge/discharge cycle test were performed according to the following steps (1) to (8).
(1) A cell was prepared so as to have a rated capacity of 1 Ah.
(2) In an environment of 25° C., the obtained cell was charged at a constant current rate of 0.2 C rate (that is, 200 mA) and with a cut-off voltage of 3.6 V, and then charged at a constant voltage with a cut-off current of 0.05 C rate (that is, 20 mA).
(3) The cell was discharged for capacity confirmation in an environment of 25° C. at a constant current rate of 0.2 C and with a cut-off voltage of 2.0 V. The discharge capacity at this time was set as the reference capacity, and the reference capacity was set as the current value at 1 C rate (that is, 1,000 mA).
(4) In an environment of 25° C., the cell was charged at a constant current rate of 0.2 C rate (that is, 200 mA) and with a cut-off voltage of 3.6 V, and then charged at a constant voltage with a cut-off current of 0.05 C rate (that is, 20 mA). From this state, the cell was discharged at 1.0 C rate and with a cut-off voltage of 2.0 V, and a discharge capacity obtained as a result of this process was designated A1.
(5) In an environment of 25° C., the cell was charged at a constant current rate of 0.2 C rate (that is, 200 mA) and with a cut-off voltage of 3.6 V, and then charged at a constant voltage with a cut-off current of 0.05 C rate (that is, 20 mA). From this state, the cell was stored in a −30° C. environment for 3 hours. Then, after confirming that the cell had returned to the same temperature as the ambient temperature, it was discharged at 1.0 C rate (that is, 1000 mA) and with a cut-off voltage of 2.0 V. The discharge capacity obtained as a result of this process was designated A2, and the A2/A1 ratio was calculated as a percentage to evaluate the low-temperature output in the initial state (initial low-temperature output).
(6) After (5), the cell was stored in a 25° C. environment for 3 hours. Then, after confirming that the cell had returned to the same temperature as the ambient temperature, it was discharged at 0.2 C rate (that is, 200 mA) and with a cut-off voltage of 2.0 V.
(7) In an environment of 25° C., the cell was charged at a constant current rate of 3.0 C rate (that is, 3000 mA) and with a cut-off voltage of 3.6 V, and then charged at a constant voltage with a cut-off current of 0.05 C rate (that is, 20 mA), followed by a 10-second pause. Then, the cell was discharged at a constant current rate of 3.0 C rate (that is, 3000 mA) and with a cut-off voltage of 2. 0 V, followed by a 10-second pause.
(8) A cycle test was performed in which the procedure described in (7) was repeated 1,000 times.
(5) In an environment of 25° C., the cell was charged at a constant current rate of 0.2 C rate (that is, 200 mA) and with a cut-off voltage of 3.6 V, and then charged at a constant voltage with a cut-off current of 0.05 C rate (that is, 20 mA). From this state, the cell was stored in a −30° C. environment for 3 hours. Then, after confirming that the cell had returned to the same temperature as the ambient temperature, it was discharged at 1.0 C rate (that is, 1000 mA) and with a cut-off voltage of 2.0 V. The discharge capacity obtained as a result of this process was designated A3, and the A3/A1 ratio was calculated as a percentage to evaluate the low-temperature output after the cycle test (post-1000 cycle low-temperature output).

### (Materials Used)

### <Negative Electrode>

A negative electrode was produced by the following method.

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a copper foil (thickness 8 μm) and vacuum dried at 100° C. Then, the resulting was pressure-pressed under a load of 2 kN to obtain a negative electrode sheet. The obtained negative electrode sheet was punched to obtain a negative electrode.

### <Positive Electrode Current Collector>

A positive electrode current collector was produced by the following method.

A slurry was obtained by mixing 100 parts by mass of carbon black, 40 parts by mass of polyvinylidene fluoride as a binder, and N-methylpyrrolidone (NMP) as a solvent. The amount of NMP used was the amount required for applying the slurry.

The obtained slurry was applied to both sides of a 15 μm-thick aluminum foil (positive electrode current collector main body) by a gravure method so as to allow the resulting current collector coating layers after drying (total of layers on both sides) to have a thickness of 2 μm, and dried to remove the solvent, thereby obtaining a positive electrode current collector. The current collector coating layers on both surfaces were formed so as to have the same amount of coating and the same thickness. For the Examples using the obtained positive electrode collector, the “Presence or absence of current collector coating layer” column in the tables is marked “Present”.

In the Examples marked “Absent” in the “Presence or absence of current collector coating layer” column in the tables, a positive electrode current collector without a current collector coating layer (i.e., only the positive electrode current collector main body itself) was used.

### <Positive Electrode Active Material Particles>

As the positive electrode active material particles, coated particles having a core section formed of lithium iron phosphate and an active material coating section formed of carbon (hereinafter referred to as “LFP coated particles”) were used.

### <<Positive Electrode Active Material Particles M1>>

Average particle size: 13.8 μm.
Carbon content: 1.5% (by mass).
Coverage of active material coating section (C-coat coverage): Prepared to be 90%.

### <<Positive Electrode Active Material Particles M2>>

Average particle size: 1.1 μm.
Carbon content: 1.0% (by mass).
C-coat coverage: Prepared to be 70%.

### <<Positive Electrode Active Material Particles M3>>

Average particle size: 10.2 μm.
Carbon content: 0.3% (by mass).
C-coat coverage: Prepared to be 70%.

### <<Positive Electrode Active Material Particles M4>>

Average particle size: 0.6 μm.
Carbon content: 2.5% (by mass).
C-coat coverage: Prepared to be 70%.

### <<Positive Electrode Active Material Particles M5>>

Average particle size: 0.9 μm.
Carbon content: 1.0% (by mass).
C-coat coverage: Prepared to be 30%.

### <<Positive Electrode Active Material Particles M6>>

Average particle size: 10.6 μm.
Carbon content: 1.5% (by mass).
C-coat coverage: Prepared to be 30%.

### <<Positive Electrode Active Material Particles M7>>

Average particle size: 9.9 μm.
Carbon content: 1.0% (by mass).
C-coat coverage: Prepared to be 30%.

### <<Positive Electrode Active Material Particles M8>>

Average particle size: 0.9 μm.
Carbon content: 0.3% (by mass).
C-coat coverage: Prepared to be 70%.

### <Others>

Carbon black (CB) or carbon nanotube (CNT) was used as the conducting agent. Impurities in the CB and the CNT are below the quantification limit; therefore, both of the CB and the CNT can be regarded as having a carbon content of 100% by mass.

Polyvinylidene fluoride (PVDF) was used as binder. N-methylpyrrolidone (NMP) was used as a solvent.

### Examples 1 to 4, 6 and 7, and Comparative Examples 1, 2 and 4 to 6

A positive electrode active material layer was formed by the following method.

With the blending ratios shown in Tables 1 and 2, the positive electrode active material particles (amounts shown in the tables), the conducting agent (amounts shown in the tables), the binder (1% by mass), and the solvent (NMP) were mixed in a planetary mixer to obtain positive electrode compositions. The total amount of the positive electrode active material particles, conducting agent and binder was 100% by mass. The amount of the solvent was the amount required to apply the positive electrode compositions. The “%” indicating the compositions in the tables is % by mass.

The obtained positive electrode composition was applied to both surfaces of the positive electrode current collector, and after pre-drying, the applied composition was vacuum-dried at 120° C. to form positive electrode active material layers. The coating volume of the positive electrode composition was 20 mg/cm² (total volume for both sides). The positive electrode active material layers on both surfaces of the positive electrode current collector were formed so as to have the same coating amount and the same thickness. The obtained laminate was pressure-pressed to obtain a positive electrode sheet. The volume density of the composite laminate was adjusted by the pressing pressure of the pressure press. The resulting positive electrode sheet had a composite laminate, which was a laminate of a current collector coating layer and a positive electrode active material layer, formed on the positive electrode current collector main body.

The obtained positive electrode sheet was punched to obtain a positive electrode. The obtained positive electrode was subjected to scanning Auger electron spectroscopy (AES), and the results are shown in the tables.

A non-aqueous electrolyte secondary battery having a configuration shown in FIG. 2 was manufactured by the following method.

LiPF₆ as an electrolyte was dissolved at 1 mol/L in a solvent in which ethylene carbonate (EC) and diethyl carbonate (DEC) were mixed at a volume ratio, EC:DEC, of 3:7, to thereby prepare a non-aqueous electrolytic solution.

The positive electrode 1 and the negative electrode 3 obtained in each of the Examples were alternately interleaved through a separator 2 to prepare an electrode layered body with its outermost layer being the negative electrode 3. A polyolefin film (thickness 15 μm) was used as the separator.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolyte solution was injected from one side left unsealed, and this one side was vacuum-sealed to manufacture a non-aqueous electrolyte secondary battery (laminate cell) of each of the Examples.

The low-temperature discharge performance of the obtained non-aqueous electrolyte secondary battery were evaluated, and the results are shown in the tables.

### Example 5

A positive electrode and a non-aqueous electrolyte secondary battery were obtained in the same manner as in Example 1, except that according to the composition shown in Table 1, 99% by mass of the positive electrode active material particles, 1% by mass of the binder, and the solvent were mixed in a planetary mixer, and the resulting was processed in a wet jet mill for one pass at a pressure of 100 MPa to obtain a positive electrode composition. The low-temperature discharge performance of the obtained non-aqueous electrolyte secondary battery were evaluated, and the results are shown in the tables.

### Comparative Example 3

A positive electrode and a non-aqueous electrolyte secondary battery were obtained in the same manner as in Example 1, except that the positive electrode composition was obtained as follows. According to the composition shown in Table 2, 99% by mass of the positive electrode active material particles, 1% by mass of the binder, and the solvent were mixed in a planetary mixer, and the resulting was processed in a wet bead mill for one pass under conditions of a peripheral speed of 10 m/s, zirconia used as bead material, a bead filling rate of 85%, and a bead diameter of 0.3 mm, to obtain a positive electrode composition. The low-temperature discharge performance of the obtained non-aqueous electrolyte secondary battery were evaluated, and the results are shown in the tables.

Further, wet bead mills apply significantly stronger shearing and crushing forces than other mixers. In this comparative example, a wet bead mill was used to enable a shearing force strong enough to peel off the active material coating layer and a crushing force strong enough to cut and destroy the active material particles.

TABLE 1

| | | | Ex. 1 | Ex. 2 | Ex. 3 | Ex. 4 | Ex. 5 | Ex. 6 | Ex. 7 |
|---|---|---|---|---|---|---|---|---|---|
| Positive | Type of active material | | M2 | M1 | M1 | M1 | M1 | M3 | M4 |
| electrode | Average particle size | μm | 1.1 | 13.8 | 13.8 | 13.8 | 13.8 | 10.2 | 0.6 |
| active | C-coat coverage | % | 70 | 90 | 90 | 90 | 90 | 70 | 70 |
| material | Carbon content of | % | 1.0 | 1.5 | 1.5 | 1.5 | 1.5 | 0.3 | 2.5 |
| | active material | | | | | | | | |
| Production | Active material | % | 99 | 99 | 98 | 99 | 99 | 99 | 99 |
| conditions | Binder | % | 1 | 1 | 1 | 1 | 1 | 1 | 1 |
| for positive | Conducting agent | % | 0 | 0 | 1 | 0 | 0 | 0 | 0 |
| electrode | Conductive | % | 1.0 | 1.5 | 2.5 | 1.5 | 1.5 | 0.3 | 2.5 |
| | carbon content | | | | | | | | |
| | Mixer | | Planetary | Planetary | Planetary | Planetary | Planetary mixer | Planetary | Planetary |
| | | | mixer | mixer | mixer | mixer | Wet bead mill | mixer | mixer |
| | Current collector | | Present | Present | Present | Absent | Present | Present | Present |
| | coating layer | | | | | | | | |
| Auger | Cmax | | 950 | 1050 | 1250 | 1050 | 1150 | 750 | 1350 |
| electron | Femax | | 70 | 70 | 50 | 70 | 70 | 70 | 70 |
| spectroscopy | Cmax/Femax | | 13.6 | 15.0 | 25.0 | 15.0 | 16.4 | 10.7 | 19.3 |
| results | D90 | | 1250 | 1250 | 1650 | 1250 | 1350 | 1150 | 1650 |
| | D10 | | 650 | 950 | 1150 | 950 | 1050 | 550 | 1150 |
| | D90/D10 | | 1.9 | 1.3 | 1.4 | 1.3 | 1.3 | 2.1 | 1.4 |
| Battery | Initial low- | % | 71 | 78 | 77 | 72 | 83 | 66 | 74 |
| performance | temperature | | | | | | | | |
| evaluation | output (A2/A1) | | | | | | | | |
| | Post-1000-cycle | % | 65 | 74 | 66 | 58 | 80 | 59 | 63 |
| | low-temperature | | | | | | | | |
| | output (A3/A1) | | | | | | | | |

TABLE 2

| | | | Comp. | Comp. | Comp. | Comp. | Comp. | Comp. |
|---|---|---|---|---|---|---|---|---|
| | | | Ex. 1 | Ex. 2 | Ex. 3 | Ex. 4 | Ex. 5 | Ex. 6 |
| Positive | Type of active material | | M5 | M1 | M1 | M6 | M7 | M8 |
| electrode | Average particle size | μm | 0.9 | 13.8 | 13.8 | 10.6 | 9.9 | 0.9 |
| active | C-coat coverage | % | 30 | 90 | 90 | 30 | 30 | 70 |
| material | Carbon content of | % | 1.0 | 1.5 | 1.5 | 1.5 | 1.0 | 0.3 |
| | active material | | | | | | | |
| Production | Active material | % | 99 | 94 | 99 | 94 | 99 | 99 |
| conditions | Binder | % | 1 | 1 | 1 | 1 | 1 | 1 |
| for positive | Conducting agent | % | 0 | 5 | 0 | 5 | 0 | 0 |
| electrode | Conductive | % | 1.0 | 6.5 | 1.5 | 6.5 | 1.0 | 0.3 |
| | carbon content | | | | | | | |
| | Mixer | | Planetary | Planetary | Planetary mixer | Planetary | Planetary | Planetary |
| | | | mixer | mixer | Wet bead mill | mixer | mixer | mixer |
| | Current collector | | Present | Present | Present | Present | Present | Present |
| | coating layer | | | | | | | |
| Auger | Cmax | | 350 | 1450 | 1050 | 1450 | 850 | 750 |
| electron | Femax | | 110 | 10 | 130 | 170 | 170 | 110 |
| spectroscopy | Cmax/Femax | | 3.2 | 145.0 | 8.1 | 8.5 | 5.0 | 6.8 |
| results | D90 | | 950 | 1950 | 1350 | 1950 | 1250 | 1050 |
| | D10 | | 250 | 1050 | 450 | 750 | 750 | 550 |
| | D90/D10 | | 3.8 | 1.9 | 3.0 | 2.6 | 1.7 | 1.9 |
| Battery | Initial low- | % | 43 | 77 | 31 | 50 | 14 | 35 |
| performance | temperature | | | | | | | |
| evaluation | output (A2/A1) | | | | | | | |
| | Post-1000-cycle | % | 15 | 24 | 7 | 16 | 2 | 17 |
| | low-temperature | | | | | | | |
| | output (A3/A1) | | | | | | | |

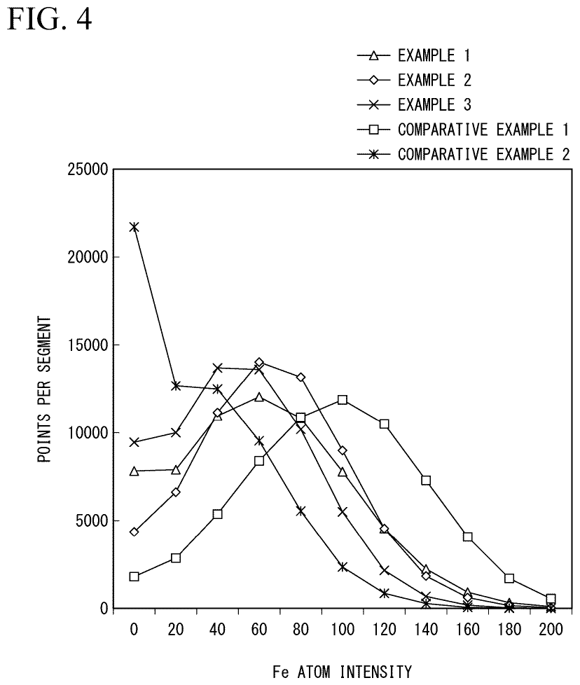

The evaluation results of each example are shown in Tables 1 and 2. In addition, for Examples 1 to 3 and Comparative Examples 1 and 2, the distribution of the C atom intensity (carbon atom intensity) is shown in FIG. 3, and the distribution of the Fe atom intensity (iron atom intensity) is shown in FIG. 4.

As shown in Tables 1 and 2, Examples 1 to 7 to which the present invention was applied showed an initial low-temperature output (A2/A1) of 66 to 83%, and a post-1000-cycle low-temperature output (A3/A1) of 58 to 80%.

Comparative Examples 1 and 3 to 6, in which Cmax/Femax was 3.2 to 8.5, showed an initial low-temperature output of 14 to 43%, and a post-1000-cycle low-temperature output of 2 to 17%.

Comparative Example 2, in which Cmax/Femax was 145, showed an initial low-temperature output of 77%, but a post-1000-cycle low-temperature output of 24%.

From these results, it was confirmed that application of the present invention improves output performance in low-temperature environments and is less susceptible to deterioration (excellent in cycle performance).

### EXPLANATION OF REFERENCE NUMERALS

1 Positive electrode
2 Separator
3 Negative electrode
4 Non-aqueous electrolyte solution
5 Outer casing
10 Non-aqueous electrolyte secondary cell
11 Current collector (positive electrode current collector)
12 Positive electrode active material layer
13 Exposed section of positive electrode current collector
14 Positive electrode current collector main body
15 Current collector coating layer

1. A positive electrode for a non-aqueous electrolyte secondary battery, comprising a positive electrode current collector and a positive electrode active material layer which comprises one or more positive electrode active material particles and is provided on one or both surfaces of the positive electrode current collector, wherein:
the positive electrode active material layer comprises carbon atoms and iron atoms, and
Cmax/Femax is 10.0 or more and 35.0 or less, which is a ratio of the most frequent carbon atom intensity Cmax to the most frequent iron atom intensity Femax, wherein the Cmax and the Femax are obtained from histograms of carbon atom intensity and iron atom intensity, each determined by performing scanning Auger electron spectroscopy with respect to a total of 65,536 measurement points formed by vertically aligned 256 points×horizontally aligned 256 points within an area of 100 μm×100 m on a surface of the positive electrode active material layer.

2. The positive electrode according to claim 1, wherein C90/C10 is 1.0 or more and 2.5 or less, which is a ratio of C90 that is a top 10% value to C10 that is in a bottom 10% value, wherein the C90 and the C10 are obtained from the histogram of the carbon atom intensity determined by performing the scanning Auger electron spectroscopy with respect to the measurement points.

3. The positive electrode according to claim 1, wherein at least a part of the positive electrode active material particles has a core section formed of a positive electrode active material and an active material coating section that covers at least a part of surface of the core section, and the active material coating section comprises conductive carbon.

4. The positive electrode according to claim 3, wherein an amount of the conductive carbon in the positive electrode active material layer is 0.5% by mass or more and less than 3% by mass, based on a total mass of the positive electrode active material layer.

5. The positive electrode for a non-aqueous electrolyte secondary battery according to claim 1, wherein the positive electrode current collector has a current collector main body formed of a metal material, and a current collector coating layer covering at least a part of surface of the current collector main body,
the current collector coating layer faces the positive electrode active material layer, and
the current collector coating layer comprises conductive carbon.

6. The positive electrode active material according to claim 1, wherein the positive electrode active material particles comprise a compound represented by a formula LiFeₓM₍₁₋ₓ₎PO₄, wherein 0≤x≤1, M is Co, Ni, Mn, Al, Ti or Zr.

7. The positive electrode according to claim 1, wherein the positive electrode active material layer further comprises a conducting agent.

8. The positive electrode according to claim 1, wherein the positive electrode active material layer does not contain a conducting agent.

9. A non-aqueous electrolyte secondary battery, comprising the positive electrode of claim 1, a negative electrode, and a non-aqueous electrolyte disposed between the positive electrode and the negative electrode.

10. A battery module or battery system comprising a plurality of the non-aqueous electrolyte secondary batteries of claim 9.

11. The positive electrode according to claim 2, wherein at least a part of the positive electrode active material particles has a core section formed of a positive electrode active material and an active material coating section that covers at least a part of surface of the core section, and the active material coating section comprises conductive carbon.

12. The positive electrode according to claim 11, wherein an amount of the conductive carbon in the positive electrode active material layer is 0.5% by mass or more and less than 3% by mass, based on a total mass of the positive electrode active material layer.

13. The positive electrode for a non-aqueous electrolyte secondary battery according to claim 2, wherein the positive electrode current collector has a current collector main body formed of a metal material, and a current collector coating layer covering at least a part of surface of the current collector main body,
the current collector coating layer faces the positive electrode active material layer, and
the current collector coating layer comprises conductive carbon.

14. The positive electrode active material according to claim 2, wherein the positive electrode active material particles comprise a compound represented by a formula LiFeₓM₍₁₋ₓ₎PO₄, wherein 0≤x≤1, M is Co, Ni, Mn, Al, Ti or Zr.

15. The positive electrode according to claim 2, wherein the positive electrode active material layer further comprises a conducting agent.

16. The positive electrode according to claim 2, wherein the positive electrode active material layer does not contain a conducting agent.

17. A non-aqueous electrolyte secondary battery, comprising the positive electrode of claim 2, a negative electrode, and a non-aqueous electrolyte disposed between the positive electrode and the negative electrode.

18. A battery module or battery system comprising a plurality of the non-aqueous electrolyte secondary batteries of claim 17.
